(19) United States
(12) Patent Application Publication
(10) Pub. No.: US 2009/0107768 A1
(43) Pub. Date: Apr. 30, 2009

(54) Ladder

(76) Inventor: James S. McCoolidge, Omaha, NE (US)

Correspondence Address: THOMTE LAW OFFICE, L.L.C., 2120 S. 72ND STREET, SUITE 1111, OMAHA, NE, 68124, US

(21) Appl. No.: 11/977,861

(22) Filed: Oct. 26, 2007

(51) Int. Cl. E06C 1/383

(52) U.S. Cl. 182/207

(57) ABSTRACT

A ladder is disclosed which includes a pair of side rail members having step plates selectively vertically movably mounted thereon to enable the user to climb upwardly on the side rail members or to climb downwardly thereon. The ladder may be converted from an A-frame type ladder to an extension type ladder.

### BACKGROUND OF THE INVENTION

1. Field of the Invention

This invention relates to a ladder and more particularly to a ladder which includes first and second spaced-apart rail members, each of which has a climbing device in the form of a step plate selectively vertically movably mounted thereon.

2. Description of the Related Art

Conventional ladders, whether they are of the A-frame type or the extension ladder type, normally comprise a pair of horizontally spaced-apart side rail members having rungs or steps extending therebetween in a vertically spaced-apart manner. The user of the ladder moves upwardly and downwardly on the ladder whether it be of the A-frame type or the extension ladder type, by stepping on the steps or rungs. Since the rungs or steps are spaced a predetermined distance apart, there is no halfway position between them. Further, the horizontal distance between the spaced-apart side rail members on the conventional ladders is not adjustable to the best of applicant's knowledge.

Additionally, the ladders of which applicant has knowledge do not have sufficient ground engaging members at the lower ends thereof which will prevent the rail members from moving downwardly into soft or wet ground thereby decreasing the stability of the ladder. Further, the conventional ladders do not always permit the user to set the proper angle of the ladder for maximum safety and do not allow the ladder to be used in a variety of ways other than originally designed.

### SUMMARY OF THE INVENTION

A ladder is provided which may be used in the conventional A-frame type or which may be used as an extension type ladder. The ladder includes first and second horizontally spaced-apart upright side rail members having upper and lower ends with first and second step plates selectively movably mounted on the first and second rail members, respectively. The first and second step plates are adapted to receive and support a foot of a person using the ladder. Each of the first and second step plates is selectively movable between first and second positions with respect to its associated rail member. Each of the first and second step plates is freely movable upwardly and downwardly with respect to its associated rail member when in its first position. Each of the step plates are in frictional engagement with the associated rail member, when in their second position, to prevent downward movement of the step plate with respect to its associated rail member. Each of the first and second step plates frictionally engage the associated rail member when downward foot pressure is supplied thereto to move the step plate to its second position by the person so that downward movement of the step plate with respect to its associated rail member is prevented. Each of the first and second step plates is selectively movable from their second position to their first position by the person's foot so that the step plate may be vertically moved upwardly or downwardly with respect to the associated rail member.

Preferably, the horizontal distance between the first and second side rail members is adjustable. When the ladder is in its A-frame configuration, the third and fourth rail members, having upper and lower ends, are pivotally secured at their upper ends to the upper ends of the first and second rail members. In the preferred embodiment, each of the rail members of the ladder has a general I-shape in cross section. In the preferred embodiment, each of the step plates have straps provided thereon to at least partially extend over the person's foot to enable the person to raise the step plate and to move the step plate from its first position to its second position. In the preferred embodiment, each of the first and second rail members have vertically spaced-apart detent openings formed therein, with each of the step plates having a detent ball or protrusion provided thereon adapted to be received by the detent openings. Each of the third and fourth rail members may be pivotally moved to a position from the A-frame ladder configuration to a position wherein they are parallel to the first and second rail members, respectively, and extend therefrom.

It is therefore a principal object of the invention to provide an improved ladder.

A further object of the invention is to provide an improved ladder which may be either used in an A-frame configuration or an extension ladder configuration.

Still another object of the invention is to provide a ladder which includes a pair of spaced-apart rail members which have climbing devices or step plates selectively vertically movably mounted thereon.

Still another object of the invention is to provide a ladder of the type described which enables a person to move step plates or climbing devices upwardly or downwardly thereon in a desired distance.

Yet another object of the invention is to provide a ladder of the type described which enables the rail members thereof to be adjustably moved with respect to one another.

Still another object of the invention is to provide a ladder of the type described which includes flat circular plates mounted on the lower ends of the rail members for additional stability.

These and other objects will be apparent to those skilled in the art.

### BRIEF DESCRIPTION OF THE DRAWINGS

FIG. 1 is a perspective view of the ladder in its A-frame configuration;

FIG. 2 is a side view of the ladder of FIG. 1;

FIG. 3 is a perspective view illustrating a step plate and its relationship with respect to a person's foot using the ladder;

FIG. 4 is a view similar to FIG. 3 except that the person has placed his/her foot on the step plate and has applied downward pressure thereon to cause the step plate to frictionally engage the associated side rail member;

FIG. 5 is a view similar to FIG. 4 except that the person has raised his/her foot to enable the step plate to be moved upwardly or downwardly with respect to its associated rail member;

FIG. 6 is a top view of the relationship of a step plate with respect to its associated rail member;

FIG. 7 is a view of the step plate; and

FIG. 8 is a perspective view illustrating the manner in which the ladder may be changed from its A-frame configuration to an extended ladder configuration.

### DETAILED DESCRIPTION OF THE INVENTION

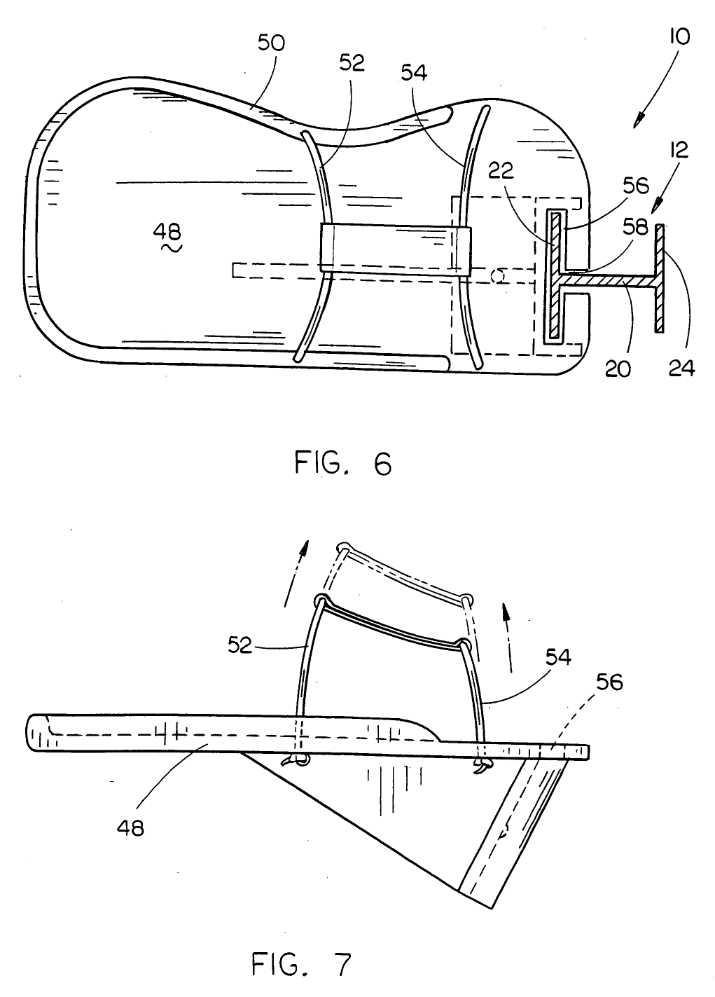

The ladder of this invention is referred to generally by the reference numeral 10. Ladder 10 includes a first upstanding side rail member 12, a second upstanding side rail member 14, a third upstanding side rail member 16, and a fourth upstanding side rail member 18. Each of the rail members 12, 14, 16 and 18 preferably have an I-beam cross section as perhaps best seen in FIG. 6. However, the second rail members may have a C-shaped cross section or a round cross section. Rail member 12, as seen in FIG. 6, includes a web 20 and flanges 22 and 24 at the opposite ends thereof. The rail members 14, 16 and 18 have identical structure. Each of the rail members 12, 14, 16 and 18 preferably have a flat circular plate 26 pivotally secured thereto about a horizontal axis to provide increased stability to the ladder as opposed to the conventional narrow feet normally provided on ladders.

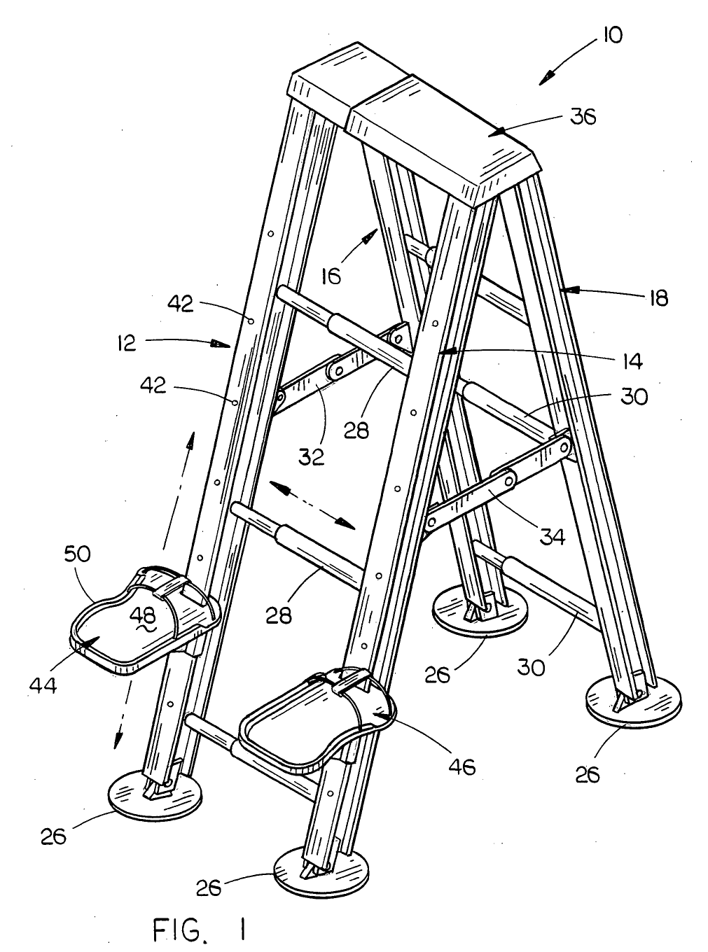

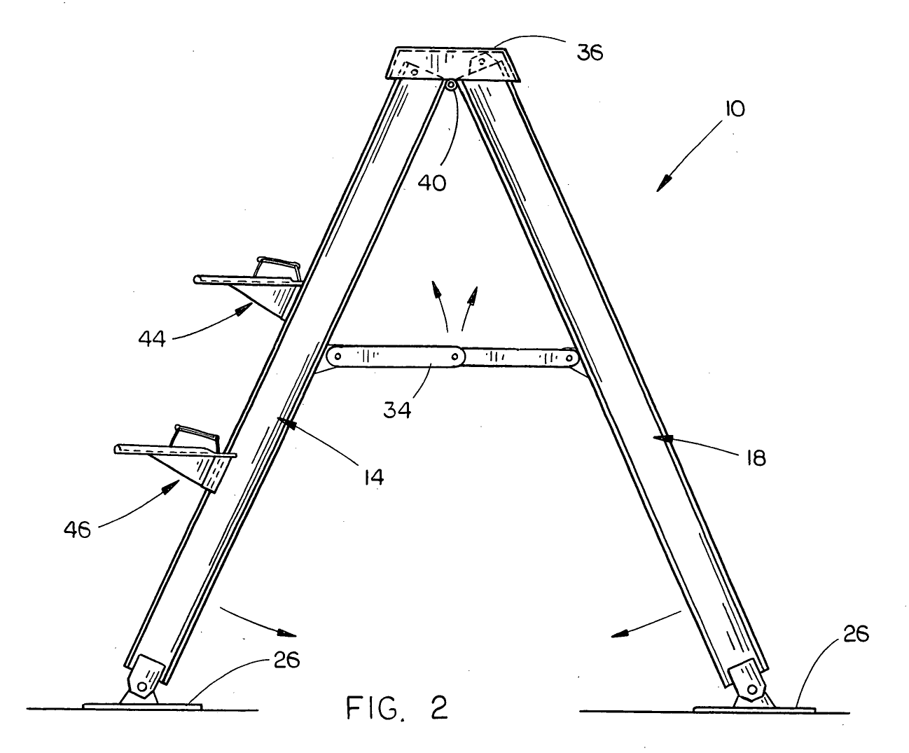

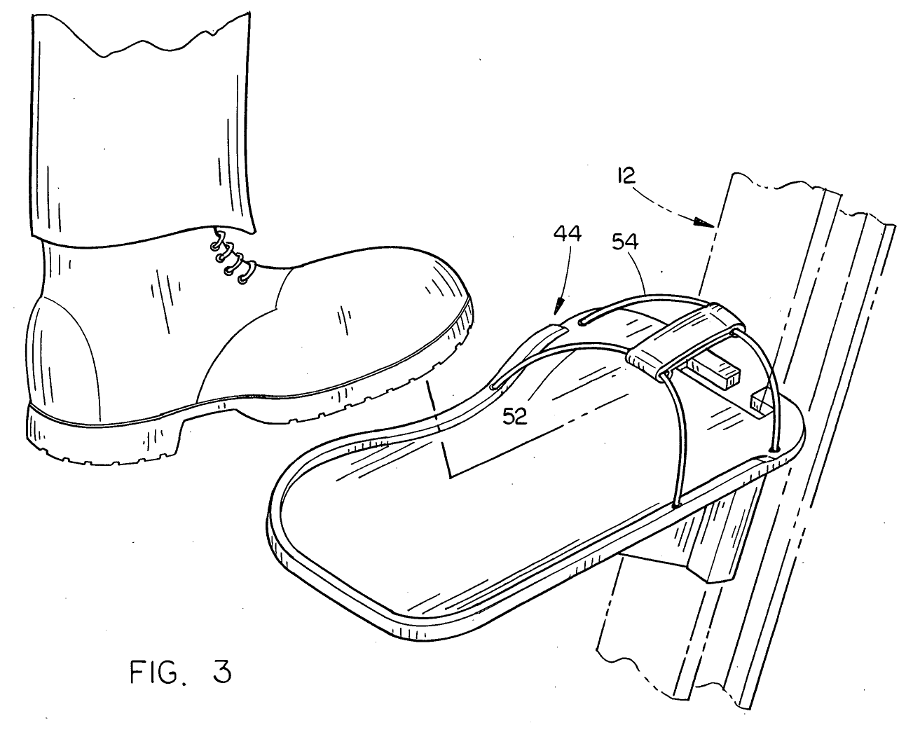

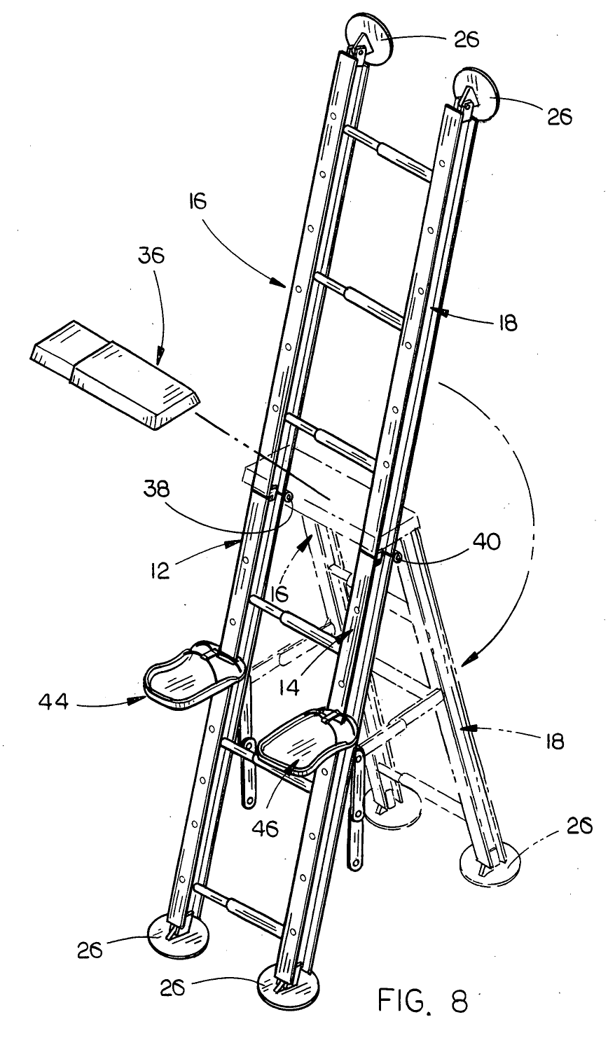

Preferably, rail members 12 and 14 are interconnected by telescoping tubes 28 including locking means of conventional design to enable the rail members 12 and 14 to be selectively horizontally spaced. Rail members 16 and 18 likewise have telescoping tubes 30 extending therebetween to enable the rail members 16 and 18 to be horizontally adjustably spaced as rail members 12 and 14 are adjustably horizontally movably spaced. Hinges 32 and 34 interconnect rail members 12, 16 and 14, 18, as illustrated in FIG. 1, to enable the ladder 10 to be moved between the operative or working position of FIG. 1 to a folded configuration in the same manner as conventional A-frame ladders. A top plate 36 which is length adjustable is positioned at the upper end of the rail members 12, 14, 16 and 18, as illustrated in the drawings, and is removable therefrom, as illustrated in FIG. 8. The upper ends of rail members 12 and 14 are pivotally connected to rail members 16 and 18 by hinges 38 and 40, respectively, so that when the top plate 36 is removed, the ladder 10 may be moved from the A-frame configuration of FIG. 1 to the extended position illustrated in FIG. 8.

The rail members 12, 14, 16 and 18 are provided with a plurality of detent openings 42 formed therein in a vertically spaced manner for a purpose to be described hereinafter.

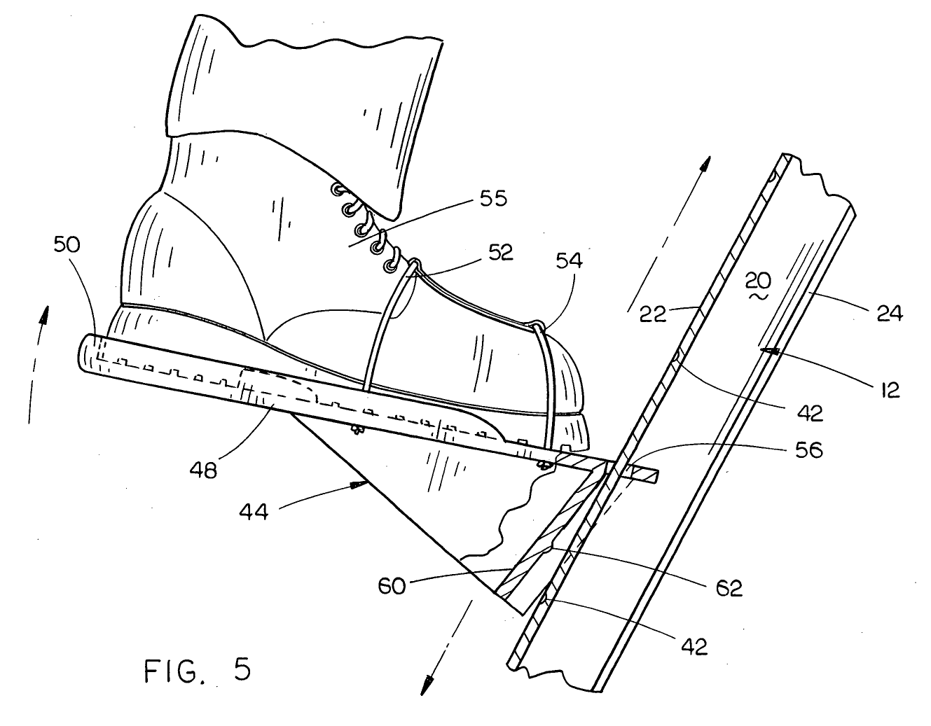

The numerals 44 and 46 refer to climbing devices or step plates which are selectively movably mounted on the rail members and which are adapted to receive the left foot of the user or the right foot of the user. The step plates 44 and 46 are also selectively removably mounted on the rail members. The removable mounting of the step plates permits the step plates to be removed from said member during times of non-use to prevent unauthorized use of the ladder. Inasmuch as the step plates 44 and 46 are identical, only step plate 44 will be described in detail. Step plate 44 includes a base portion 48 having an upstanding wall 50 at the outer side thereof which is adapted to prevent the person's foot from slipping laterally from the base portion 48. At least a pair of straps 52 and 54 extend upwardly from the base portion 48 and are adapted to receive the person's foot 55 therein, as illustrated in FIG. 5. The forward end of base plate 48 has an elongated slot 56 formed therein which is adapted to receive the flange 22 of the rail member 12, as illustrated in FIG. 6. Slot 56 communicates with a slot 58 which receives the web 20 of the rail member 12, as illustrated in FIG. 6. A support plate 60 extends downwardly from the inner end of base plate 48 and has a detent ball-like protrusion 62 extending therefrom which is adapted to be received by one of the detent openings 42 if so desired.

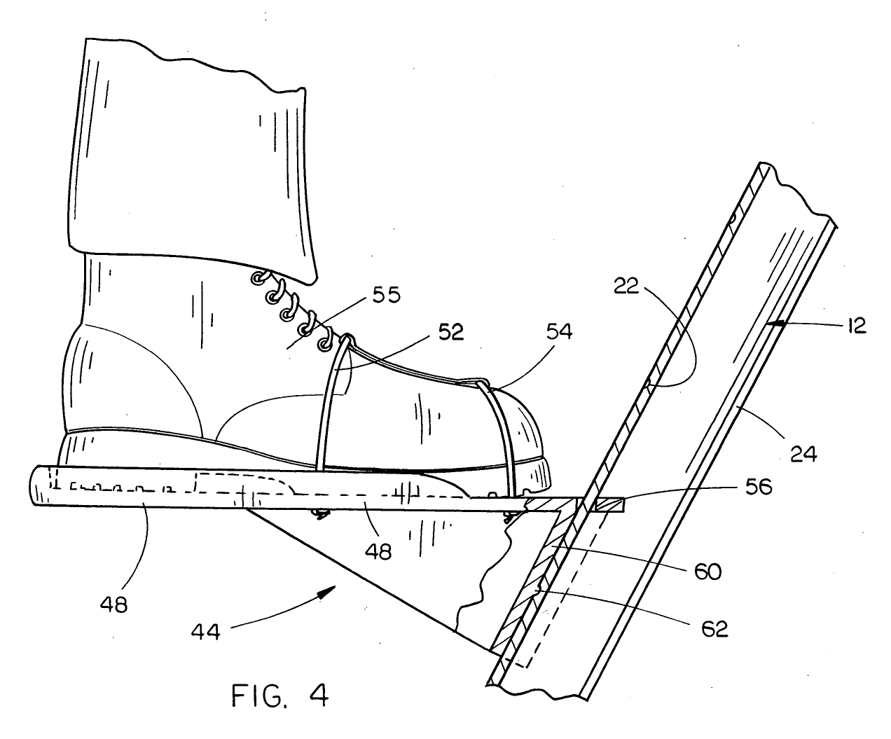

When the step plate 44 is in the position of FIG. 5, the step plate 44 is free to move upwardly and downwardly with respect to the rail member 12 since there is no frictional engagement therebetween. When downward force is applied to the step plate 44, as illustrated in FIG. 4, the member 60 frictionally engages the outer side of flange 22 and the base plate 48 engages the web 22 at the opposite sides of the slot 56, as illustrated in FIG. 4, so that frictional engagement is created between the step plate 44 and the rail member 12 to prevent downward movement of the step plate 44 with respect to the rail member 12. When in the position of FIG. 4, the ball-like detent 62 is received within one of the openings 42 which assists the user of the ladder to feel somewhat more confident that the step plate will not move downwardly when in the position of FIG. 4. The detent ball in the step plate also holds the step plate in position when the user dismounts the ladder.

Thus, the user of the ladder is able climb upwardly on the ladder through the use of the step plates 44 and 46 and to move downwardly on the ladder through the use of the step plates 44 and 46. If the user desires to move the step plate upwardly on the associated rail member, the user moves his/her foot from the position of FIG. 4 to the position of FIG. 5 so that there is no frictional engagement between the step plate and the associated rail member. When the user has raised or lowered the step plate to the desired position, the step plate is moved from the position of FIG. 5 to the position of FIG. 4 so that frictional engagement of the step plate 44 with the associated rail prevents downward movement of the step plate with respect to the associated rail member. When the user desires to move the step plate either upwardly or downwardly, the step plate is moved from the position of FIG. 4 to the position of FIG. 5 which enables the step plate to freely move upwardly or downwardly with respect to the associated rail member.

If it is desired to change the A-frame ladder configuration into an extension ladder configuration, as illustrated in FIG. 6, the top plate 36 is removed and the hinges 32 and 34 are disconnected so that the rail members 16 and 18 may be pivotally moved from the position of FIG. 1 to the position of FIG. 8 so as to be parallel with respect to the rail members 12 and 14 and to extend upwardly therefrom.

The ladder of this invention has no height limitations and may be of any length.

Thus it can be seen that a novel ladder has been provided which eliminates the need for steps or rungs to extend between the rail members of the ladder and which enables the user to precisely position his/her foot in the desired location since the step plates may be incrementally moved to the desired position, which is not possible with conventional A-frame ladders or extension ladders.

Thus it can be seen that the invention accomplishes at least all of its stated objectives.

I claim:

1. A ladder, comprising:
first and second horizontally spaced-apart upright side rail members having upper and lower ends;
a first step plate selectively movably mounted on said first side rail member;
a second step plate selectively movably mounted on said second side rail member;
said first and second step plates adapted to receive and support a foot of a person using the ladder;
each of said first and second step plates being selectively movable between first and second positions with respect to its associated side rail member;
each of said first and second step plates being freely movable upwardly and downwardly with respect to its associated side rail member when in its said first position;
each of said step plates being in frictional engagement with its associated side rail member, when in its said second position, to prevent downward movement of the step plate with respect to its associated side rail member;
each of said first and second step plates frictionally engaging its associated side rail member when downward foot pressure is supplied thereto to move the step plate to its said second position by the person so that downward movement of the step plate with respect to its associated side rail member is prevented;
each of said first and second step plates being selectively movable from its said second position to its said first position by the person's foot so that the step plate may be vertically moved upwardly or downwardly with respect to its associated side rail member.

2. The ladder of claim 1 wherein the distance between said first and second side rail members is adjustable.

3. The ladder of claim 1 wherein third and fourth side rail members, having upper and lower ends, are pivotally secured at their upper ends to said upper ends of said first and second side rail members.

4. The ladder of claim 3 wherein the distance between said first and second side rails is adjustable and wherein the distance between said third and fourth side rail members is adjustable.

5. The ladder of claim 1 wherein circular flat plates are pivotally secured to the lower ends of said first and second side rail members.

6. The ladder of claim 3 wherein circular flat plates are pivotally secured to the lower ends of said third and fourth side rail members.

7. The ladder of claim 1 wherein each of said first and second side rail members have a general I-shape in cross section.

8. The ladder of claim 1 wherein each of said step plates have straps provided thereon to at least partially extend over the person's foot.

9. The ladder of claim 3 wherein a pivotal cross brace extends between said first and third side rail members and a pivotal cross brace extends between said second and fourth side rail members.

10. The ladder of claim 1 wherein each of said first and second side rail members has vertically spaced-apart detent openings formed therein and wherein each of said step plates has a detent ball provided thereon which are adapted to be received by said detent openings.

11. The ladder of claim 3 wherein said third and fourth side rail members may be pivotally moved to a position wherein they are parallel to said first and second side rail members, respectively, and extend therefrom.
